(19) United States
(12) Patent Application Publication
(10) Pub. No.: US 2010/0061107 A1
(43) Pub. Date: Mar. 11, 2010

(54) Optical System

(76) Inventor: Pavel Jurik, Austin, TX (US)

Correspondence Address: HEINZ GRETHER PC;G2 Technology Law, P.O. Box 202858, AUSTIN, TX, 78720, US

(21) Appl. No.: 11/991,883

(22) PCT Filed: Mar. 3, 2006
(86) PCT No.: PCT/CZ2006/000011

§ 371 Date: Mar. 11, 2008

(51) Int. Cl. F21V 11/18; G02B 5/02

(52) U.S. Cl. 362/319; 359/599

(57) ABSTRACT

For wash light-type lamps for theatre and show stages there is designed an optical system having at least two optical elements with a variable mutual position, where the first optical element (4) has a central hole (5) and a translucent screen (7) moveable with respect to the central hole, the positioning of the screen with respect to the central hole (5) being coupled with a mechanism for a change of the mutual position of the optical elements.

### TECHNICAL FIELD

The invention relates to an optical system having at least two optical elements with a variable mutual position

### BACKGROUND OF THE INVENTION

There exist two basic types of lamps for light effects used for theatre and show stages. Spotlight lamps project light figures, washlight lamps work with a non-sharp light beam to provide light and/or colour to a certain scene, etc. The optical system of the washlight lamps should enable to provide for maximum luminous intensity by a small light output angle, ie. by the angle of 7 to 10 degrees, and even light intensity distribution of the light intensity by the maximum light output angle, ie. usually 50 to 60 degrees. This is achieved by so called light-zoom system which commonly consists of two optical elements with a variable mutual position. One of them or even both are moveable and the changing mutual position provides for a change of the light output angle. The current system nevertheless manifest one rather serious drawback, as s system with two optical elements looses about 20% of light intensity when compared with system having only a single optical element.

It is an object of the invention to withdraw the above presented drawback relating to the washlight-type lamps.

### DISCLOSURE AND OBJECT OF THE INVENTION

The foregoing problems are solved by an optical system in accordance with the present invention the system having at least two optical elements with a variable mutual position, where the first optical element is provided with a central hole and a translucent screen moveable with respect to the central hole. The positioning of the screen with respect to the central hole is coupled with a mechanism for a change of mutual position of the optical elements.

By a preferred embodiment the first optical element is moveable with respect to the second optical element, while the position of the screen with respect to the first optical system remains fixed. Further according to the invention the screen consists of two semicircles, the semicircles covering the central hole of first optical element while in the first limit position and being outside the central hole while in the second limit position. By a preferred embodiment the translucent screen is made of a frosted glass

By the minimum light output angle, with the maximum distance between the first and the second optical elements, the screen is fully outside the central hole of the first optical element and a light beam goes through the hole without any loss on its intensity. At this moment the first optical element is practically non-functional. On the contrary by the maximum light output angle, with the minimum distance between the first and the second optical elements, the screen completely covers the central hole of the first optical element and prevents excessive light intensity in the centre of a the light beam passing through the second optical element as the case would be with the hole being not covered by the screen.

### BRIEF DESCRIPTION OF THE DRAWINGS

By way of an example the invention will be now described with reference to the accompanying drawings.

FIG. 1 schematically illustrates position of applied means according to the invention, by the minimum light output angle, while

FIG. 2 shows positions of the means according to FIG. 1 by the maximum light output angle.

FIG. 3 presents view on the first optical system with a screen in the first limit position and

FIG. 4 offers a view on the first optical system with a screen in the second limit position

### DESCRIPTION OF PREFERRED EMBODIMENTS

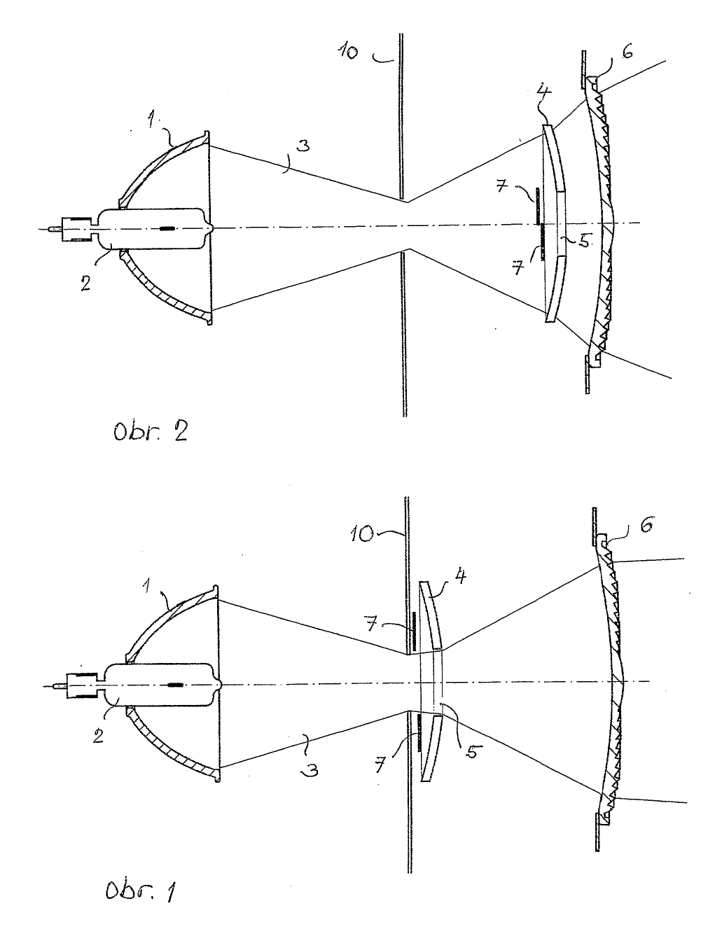

Referring to FIG. 1, there is shown an optical system for a washlight-type lamp. The system consists of a reflector 1 with a light source 2, producing a light beam 3. When reaching the reflector 1 focus, the light beam 3 has a relatively small diameter, about 30 to 50 mm. Close to the reflector 1 focus there is located the first optical element 4, which has a hole 5 in the centre, i.e. the first optical element 4 has a shape of a flat ring. In front of the first optical element 4, as seen in the direction of a light beam flow, there is positioned a translucent screen 7, the construction of which shall be discussed further. In a distance from the first optical element 4, a second optical element 6. The position of the first optical element 4 with respect to the second optical element 6 is variable, thus providing for the light-zoom effect discussed above. The first optical element 4 may be provided for by i.e. Fresnel-type lens, diffusion glass or a classic converging lens, while for the second optical element 6 there may be applied Fresnel-type lens or converging lens.

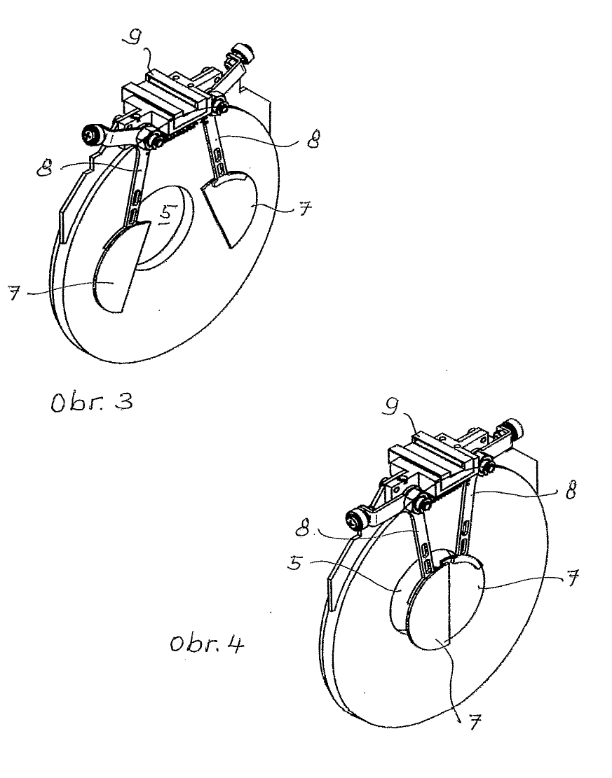

FIGS. 3 and 4 show the first optical element 4 with a preferred design of the screen. The screen consists of two semicircles 7. Each of the two parts of the screen is fixed to its separate carrier 8. The two carriers 8 are pivotally attached at a the holder 9 of the first optical element 4. In a further preferred embodiment the screen semicircles are made of a frosted glass. A diffusion glass or a Fresnel-type lens cut into two parts may be also used.

In its first limit position, when the first optical element 4 is in position close to the reflector 1 focus, as seen at FIG. 1, both screen parts are completely outside the first optical element 4 central hole 5, as can be seen on FIG. 3. and FIG. 1. The light beam goes through with full intensity, without any influence by the first optical element 4. A partition wall 10 having a circular window concentric with an optical axis of the optical system eliminates diffused light at a periphery of the light beam 3 before it reaches the first optical element 4.

In the zoom process the first optical element 4 moves toward the second optical element 6 and simultaneously the screen semicircles 7 start to move aside. The movement of the screen semicircles 7 is so coupled with the movement of the first optical element 4, that during the approx. first 20% of the track of the first optical element 4, both screen semicircles 7 are transferred from their first limit position, when they are outside the central hole 5, to their second limit position thus gradually closing together until the central hole 5 of the first element 4 is completely covered. This position, presented on FIGS. 2 and 4, remains unchanged during the remaining movement of the first optical element 4 towards the fixed position of the second optical element 6.

When covering the central hole 5 of the first optical element 4, the screen prevents concentration of the light intensity in the centre of the light beam going out of the lamp.

Mechanical coupling of the carriers of the screen semicircles 7 with the first optical element 1 is not shown as it is provided for by means known as such.

### INDUSTRIAL APPLICATIONS

The present invention is designed for washlight-type lamps for theatre and show stages.

1. Optical system having at least two optical elements with a variable mutual position, characterised in, that the first optical element (4) has a central hole (5) and a translucent screen moveable with respect to the central hole, the positioning of the screen with respect to the central hole (5) being coupled with a mechanism for a change of the mutual position of the optical elements.

2. Optical system according to claim 1, characterised in, that the first optical element (4) is moveable with respect to the second optical element (6).

3. Optical system according to claim 1 or 2, characterised in, that the position of the screen with respect to the first optical element system (4) is fixed.

4. Optical system according to any of the preceding claims, characterised in, that the screen consists of two semicircles (7), the semicircles covering the screen central hole (5) while in the first limit position and being outside the screen central hole (5) while in the second limit position.

5. Optical system according to any of the preceding claims, characterised in, that the screen is made of a frosted glass.
